(19) United States
(12) Patent Application Publication
(10) Pub. No.: US 2026/0227560 A1
(43) Pub. Date: Aug. 6, 2026

(54) LIGHTGUIDE MODULE AND LIGHT-GUIDING COMPONENT THEREOF

(71) Applicant: WNC Corporation, Hsinchu (TW)

(72) Inventors: Yu-Shuo WU, Hsinchu (TW); Yu-Chi CHEN, Hsinchu (TW)

(21) Appl. No.: 19/438,859

(22) Filed: Jan. 2, 2026

(30) Foreign Application Priority Data
Feb. 5, 2025 (TW) 114104137

(51) Int. Cl. F21V 8/00; F21V 5/00; F21V 17/02

(52) U.S. Cl. CPC G02B 6/0008; F21V 5/007; F21V 17/02; F21V 2200/13

(57) ABSTRACT

A lightguide module is provided. The lightguide module is suitable for directing light provided by a light source to a light outlet. The lightguide module includes a base and at least one light-guiding component. The base includes a plurality of slots and an opening. The light-guiding component is disposed on the base and includes a positioning post, an adjustment post, a light entering end, and a light exiting end. The light entering end corresponds to the light source, and the light exiting end corresponds to the light outlet. The positioning post is inserted into one of the slots, and the adjustment post is inserted into the opening.

### CROSS REFERENCE TO RELATED APPLICATIONS

This application claims the benefit of priority to Taiwan Patent Application No. 114104137, filed on February 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### BACKGROUND OF THE INVENTION

### Field of the Invention

The present disclosure relates to a lightguide module, particularly concerning a lightguide module capable of adjusting the light emitting distance.

### Description of the Related Art

Various electronic devices available on the market, such as gaming consoles and servers, are equipped with indicator lights. The primary function of these indicator lights is to provide users with visual cues for operation or status indication, enabling users to quickly understand the operational status or receive fault alerts of the device. However, there is no universal standard for the specifications of indicator lights, such as spacing, quantity, and position, resulting in potentially significant design differences among different manufacturers or models.

When the spacing or quantity of indicator lights in the same series of models is adjusted, the arrangement of lights may change due to changes in demand or functional expansion. At this time, it is necessary to design new light-guiding components to direct the light, ensuring that the light is accurately transmitted to the surface of the casing, providing a good display effect. However, such changes typically lead to various difficulties, such as the need to redesign the molds for the light-guiding components and adjust the mold structure to accommodate the new specifications of light design. This not only increases the mold opening costs but may also significantly extend the overall development time, thereby affecting the product's launch time and market competitiveness. Additionally, during the development process, multiple mold trials and verifications may be required, further increasing resource consumption and risk.

### BRIEF SUMMARY OF THE INVENTION

An embodiment of the present disclosure aims to solve the problems of conventional technology by providing a lightguide module suitable for directing light provided by a first light source to a first light outlet and light provided by a second light source to a second light outlet. The module includes a base, a first light-guiding component, and a second light-guiding component. The first light-guiding component is movably disposed on the base and includes a first light entering end and a first light exiting end, the first light entering end corresponding to the first light source and the first light exiting end corresponding to the first light outlet. The second light-guiding component is movably disposed on the base and includes a second light entering end and a second light exiting end, the second light entering end corresponding to the second light source and the second light exiting end corresponding to the second light outlet.

In one embodiment, the first light-guiding component includes a first light guide pipe, a first light entering portion, and a first light exiting portion. The first light entering portion is adjustably disposed at one end of the first light guide pipe, and the first light exiting portion is adjustably disposed at the other end of the first light guide pipe. The first light entering end is located on the first light entering portion, and the first light exiting end is located on the first light exiting portion. The second light-guiding component includes a second light guide pipe, a second light entering portion, and a second light exiting portion. The second light entering portion is adjustably disposed at one end of the second light guide pipe, and the second light exiting portion is adjustably disposed at the other end of the second light guide pipe. The second light entering end is located on the second light entering portion, and the second light exiting end is located on the second light exiting portion.

In one embodiment, the base includes a first slot, a second slot, and an opening. The first light guide pipe includes a first adjustment post and a first positioning post, and the second light guide pipe includes a second adjustment post and a second positioning post. The first positioning post is adapted to move along the first slot, the second positioning post is adapted to move along the second slot, and the first adjustment post and the second adjustment post are adapted to move along the opening.

In one embodiment, the first slot and the second slot are arranged along a first direction, and the opening extends along a second direction. The first slot and the second slot each extend along the second direction, the first direction is perpendicular to the second direction.

In one embodiment, the first light entering end and the second light entering end are arranged along the first direction, and the first light exiting end and the second light exiting end are arranged along the second direction.

In one embodiment, the first positioning post is tightly fitted within the first slot, and the second positioning post is tightly fitted within the second slot. The first adjustment post and the second adjustment post are tightly fitted within the opening.

In one embodiment, at least one interference protrusion is formed on the first positioning post or the first adjustment post. The interference protrusion abuts against the first slot or the opening.

In one embodiment, the lightguide module further includes a light-blocking strip, which is disposed on the base and located between the first light guide pipe and the second light guide pipe.

In another embodiment, the present disclosure provides a lightguide module suitable for directing light provided by a light source to a light outlet. The lightguide module includes a base and at least one light-guiding component. The base includes a plurality of slots and an opening. The light-guiding component is disposed on the base and includes a positioning post, an adjustment post, a light entering end, and a light exiting end. The light entering end corresponds to the light source, and the light exiting end corresponds to the light outlet. The positioning post is inserted into one of the slots, and the adjustment post is inserted into the opening.

In one embodiment, the light-guiding component includes a light guide pipe, a light entering portion, and a light exiting portion. The light entering portion is adjustably disposed at one end of the light guide pipe, and the light exiting portion is adjustably disposed at the other end of the light guide pipe. The light entering end is located on the light entering portion, and the light exiting end is located on the light exiting portion. The positioning post and the adjustment post are formed on the light guide pipe.

In one embodiment, the slots are arranged along a first direction, and the opening extends along a second direction. The slots each extend along the second direction, the first direction is perpendicular to the second direction.

In one embodiment, the light entering portion is threadably disposed at one end of the light guide pipe, and the light exiting portion is threadably disposed at the other end of the light guide pipe.

In one embodiment, the light entering portion is tightly fitted at one end of the light guide pipe, and the light exiting portion is tightly fitted at the other end of the light guide pipe.

In one embodiment, the light entering portion is snap-fitted at one end of the light guide pipe, and the light exiting portion is snap-fitted at the other end of the light guide pipe.

In one embodiment, each light guide pipe includes a plurality of first snap-fit holes and a plurality of second snap-fit holes. The light entering portion includes a first snap-fit protrusion, and the light exiting portion includes a second snap-fit protrusion. The first snap-fit protrusion is selectively coupled to one of the first snap-fit holes, and the second snap-fit protrusion is selectively coupled to one of the second snap-fit holes.

In one embodiment, the light guide pipe is adhesively fixed to the base.

In another embodiment, the present disclosure provides a light-guiding component that includes a light guide pipe, a light entering portion, and a light exiting portion. The light guide pipe includes a positioning post and an adjustment post, with the positioning post and the adjustment post formed on the light guide pipe. The light entering portion is adjustably disposed at one end of the light guide pipe. The light exiting portion is adjustably disposed at the other end of the light guide pipe.

In one embodiment, the light guide pipe is L-shaped.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The disclosure can be more fully understood by reading the subsequent detailed description and examples with references made to the accompanying drawings, wherein:

FIG. 1 shows an electronic device employing the lightguide module of an embodiment of the present disclosure.

FIG. 2A is a perspective view of the lightguide module of the first embodiment of the present disclosure.

FIG. 2B shows another view of the lightguide module of the first embodiment of the present disclosure.

FIG. 3A shows the detailed structure of the light-guiding component of the first embodiment of the present disclosure.

FIG. 3B shows the detailed structure of the light-guiding component of the second embodiment of the present disclosure.

FIG. 3C shows the detailed structure of the light-guiding component of the third embodiment of the present disclosure.

FIG. 4 shows the lightguide module of another embodiment of the present disclosure.

### DETAILED DESCRIPTION OF THE INVENTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

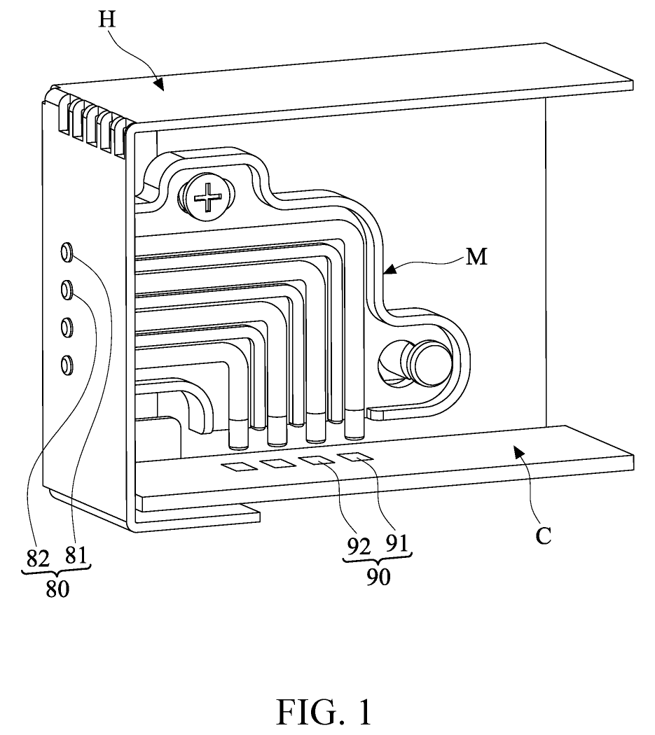

FIG. 1 shows an electronic device employing the lightguide module of an embodiment of the present disclosure. Referring to FIG. 1, the electronic device includes an enclosure H, a circuit board C, and a lightguide module M. The circuit board C is equipped with a plurality of light sources 90. The enclosure H has a plurality of light outlets 80. The lightguide module M is suitable for directing light provided by a first light source 91 to a first light outlet 81 and light provided by a second light source 92 to a second light outlet 82.

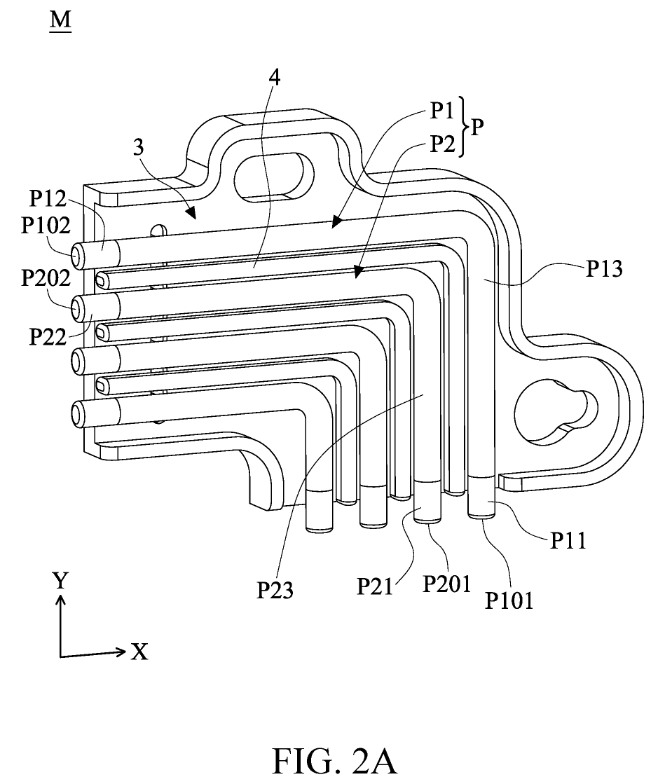

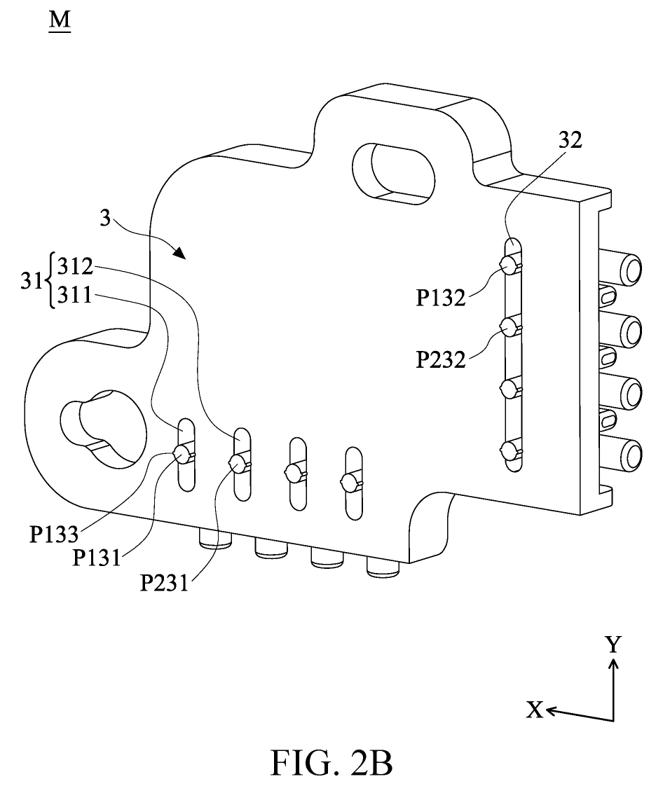

FIG. 2A is a perspective view of the lightguide module of the first embodiment of the present disclosure. FIG. 2B shows another view of the lightguide module of the first embodiment of the present disclosure. Referring to FIGS. 1, 2A, and 2B, the lightguide module M includes a base 3, a first light-guiding component P1, and a second light-guiding component P2. The first light-guiding component P1 is movably disposed on the base 3 and includes a first light entering end P101 and a first light exiting end P102. The first light entering end P101 corresponds to the first light source 91, and the first light exiting end P102 corresponds to the first light outlet 81. The first light-guiding component P1 can be L-shaped, but not limited thereto. The second light-guiding component P2 is movably disposed on the base 3 and includes a second light entering end P201 and a second light exiting end P202. The second light entering end P201 corresponds to the second light source 92, and the second light exiting end P202 corresponds to the second light outlet 82. The second light-guiding component P2 can be L-shaped, but not limited thereto.

Referring to FIGS. 1, 2A, and 2B, in one embodiment, the first light-guiding component P1 includes a first light guide pipe P13, a first light entering portion P11, and a first light exiting portion P12. The first light entering portion P11 is adjustably disposed at one end of the first light guide pipe P13, and the first light exiting portion P12 is adjustably disposed at the other end of the first light guide pipe P13. The first light entering end P101 is located on the first light entering portion P11, and the first light exiting end P102 is located on the first light exiting portion P12. The second light-guiding component P2 includes a second light guide pipe P23, a second light entering portion P21, and a second light exiting portion P22. The second light entering portion P21 is adjustably disposed at one end of the second light guide pipe P23, and the second light exiting portion P22 is adjustably disposed at the other end of the second light guide pipe P23. The second light entering end P201 is located on the second light entering portion P21, and the second light exiting end P202 is located on the second light exiting portion P22.

Referring to FIGS. 2A and 2B, in one embodiment, the base 3 includes a first slot 311, a second slot 312, and an opening 32. The first light guide pipe P13 includes a first adjustment post P132 and a first positioning post P131. The second light guide pipe P23 includes a second adjustment post P232 and a second positioning post P231. The first positioning post P131 is adapted to move along the first slot 311, the second positioning post P231 is adapted to move along the second slot 312, and the first adjustment post P132 and the second adjustment post P232 are adapted to move along the opening 32.

Referring to FIGS. 2A and 2B, in one embodiment, the first slot 311 and the second slot 312 are arranged along a first direction X, and the opening 32 extends along a second direction Y. The first slot 311 and the second slot 312 each extend along the second direction Y, with the first direction X being perpendicular to the second direction Y. In the embodiment of the present disclosure, by moving the adjustment posts (e.g., first adjustment post P132) or the positioning posts (e.g., first positioning post P131), the spacing between the light exiting ends (e.g., first light exiting end P102 and second light exiting end P202) can be adjusted, particularly in the second direction Y.

Referring to FIGS. 1, 2A, and 2B, in the embodiment of the present disclosure, the first light exiting portion P12 and the second light exiting portion P22 can themselves serve as indicator lights. However, the present disclosure is not limited thereto. In another embodiment, the first light exiting portion P12 and the second light exiting portion P22 can also correspond to transparent windows on the enclosure.

Referring to FIGS. 2A and 2B, in one embodiment, the first light entering end P101 and the second light entering end P201 are arranged along the first direction X, and the first light exiting end P102 and the second light exiting end P202 are arranged along the second direction Y.

Referring to FIGS. 2A and 2B, in one embodiment, the lightguide module M further includes a light-blocking strip 4, which is disposed on the base 3 and located between the first light guide pipe P13 and the second light guide pipe P23. In one embodiment, the light-blocking strip 4 can be a dark rubber strip, a plastic strip, or a dark UV adhesive. However, the present disclosure is not limited thereto.

Referring to FIGS. 1, 2A, and 2B, the lightguide module M provided by the present disclosure is suitable for directing light provided by the light source 90 to the light outlet 80, including a base 3 and at least one light-guiding component P. The base 3 includes a plurality of slots 31 and an opening 32. The light-guiding component P is disposed on the base 3, where each light-guiding component P includes a positioning post (e.g., first positioning post P131), an adjustment post (e.g., first adjustment post P132), a light entering end (e.g., first light entering end P101), and a light exiting end (e.g., first light exiting end P102). Each light-guiding component P can be L-shaped.

Referring to FIGS. 1, 2A, and 2B, in one embodiment, the light-guiding component P includes a light guide pipe (e.g., first light guide pipe P13), a light entering portion (e.g., first light entering portion P11), and a light exiting portion (e.g., first light exiting portion P12). The light entering portion (e.g., first light entering portion P11) is adjustably disposed at one end of the light guide pipe (e.g., first light guide pipe P13), and the light exiting portion (e.g., first light exiting portion P12) is adjustably disposed at the other end of the light guide pipe (e.g., first light guide pipe P13). In one embodiment, the light guide pipe (e.g., first light guide pipe P13) can be L-shaped.

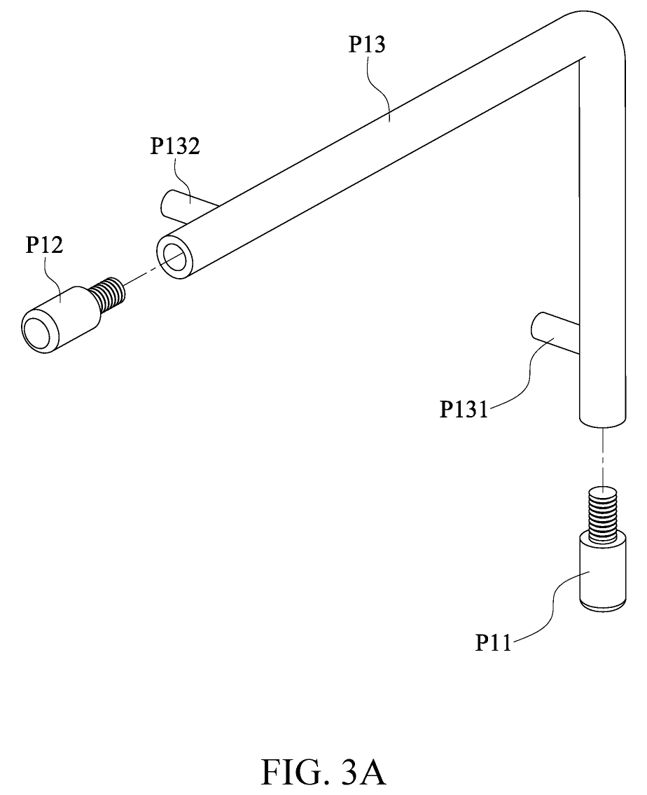

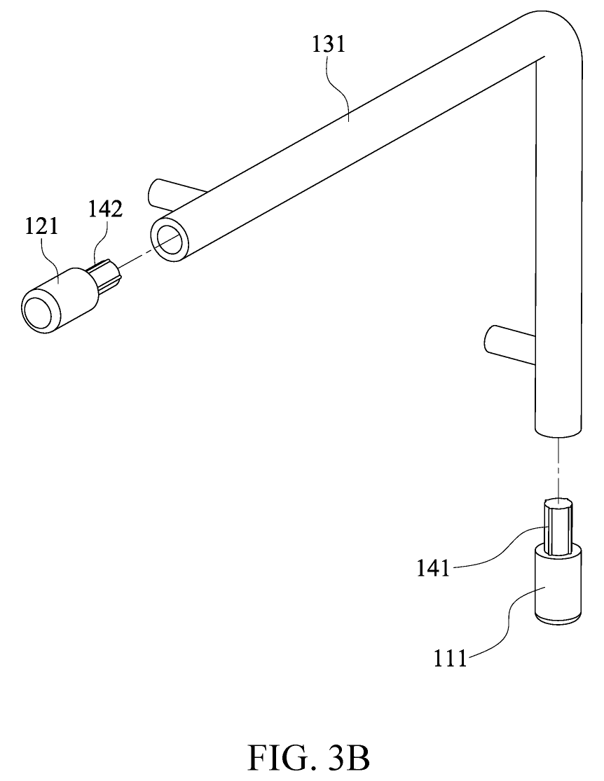

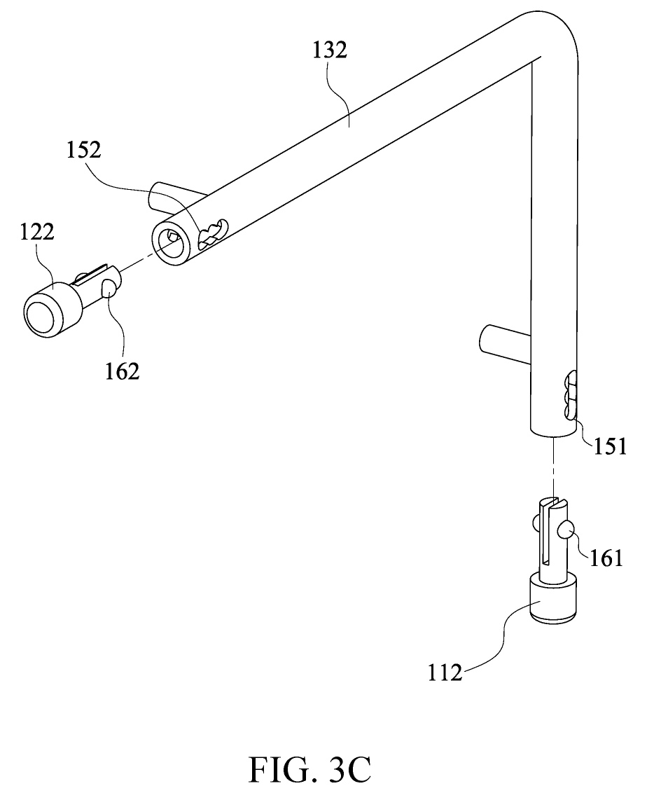

FIG. 3A shows the detailed structure of the light-guiding component of the first embodiment of the present disclosure. Referring to FIG. 3A, in one embodiment, the light entering portion (e.g., first light entering portion P11) is threadably disposed at one end of the light guide pipe (e.g., first light guide pipe P13), and the light exiting portion (e.g., first light exiting portion P12) is threadably disposed at the other end of the light guide pipe (e.g., first light guide pipe P13). In one embodiment, the relative position between the light entering portion (e.g., first light entering portion P11) and the light guide pipe (e.g., first light guide pipe P13) can be adjusted to ensure consistent distance between each light-guiding component's light entering portion and the light source.

FIG. 3B shows the detailed structure of the light-guiding component of the second embodiment of the present disclosure. Referring to FIG. 3B, in one embodiment, the light entering portion 111 is tightly fitted at one end of the light guide pipe 131, and the light exiting portion 121 is tightly fitted at the other end of the light guide pipe 131. In this embodiment, the light entering portion 111 is formed with an interference protrusion 141, and the light exiting portion 121 is formed with an interference protrusion 142. The interference protrusions 141 and 142 enhance the tight fit effect.

FIG. 3C shows the detailed structure of the light-guiding component of the third embodiment of the present disclosure. Referring to FIG. 3C, in one embodiment, the light entering portion 112 is snap-fitted at one end of the light guide pipe 132, and the light exiting portion 122 is snap-fitted at the other end of the light guide pipe 132.

Referring to FIG. 3C, in one embodiment, each light guide pipe 132 includes a plurality of first snap-fit holes 151 and a plurality of second snap-fit holes 152. The light entering portion 112 includes a first snap-fit protrusion 161, and the light exiting portion 122 includes a second snap-fit protrusion 162. The first snap-fit protrusion 161 is selectively coupled to one of the first snap-fit holes 151, and the second snap-fit protrusion 162 is selectively coupled to one of the second snap-fit holes 152.

Referring to FIGS. 2A and 2B, in one embodiment, the first positioning post P131 is tightly fitted within the first slot 311, the second positioning post P231 is tightly fitted within the second slot 312, and the first adjustment post P132 and the second adjustment post P232 are tightly fitted within the opening 32.

Referring to FIGS. 2A and 2B, in one embodiment, at least one interference protrusion P133 is formed on the first positioning post P131 or the first adjustment post P132. The interference protrusion P133 abuts against the first slot 311 or the opening 32 to enhance the tight fit effect.

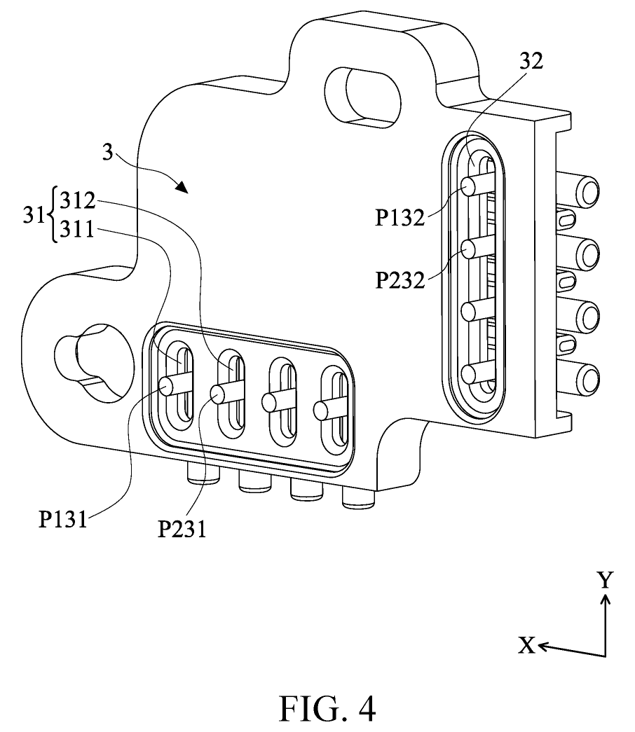

FIG. 4 shows the lightguide module of another embodiment of the present disclosure. Referring to FIG. 4, in another embodiment, the light guide pipe (e.g., first light guide pipe) can also be adhesively fixed to the base 3. In one embodiment, the first positioning post P131 and the first adjustment post P132 may not be formed with interference protrusions.

In the embodiment of the present disclosure, the relative distance between the first light-guiding component and the second light-guiding component can be adjusted, allowing for the adjustment of the distance between the first light exiting end and the second light exiting end. In one embodiment, the number of light-guiding components can be increased or decreased as needed. Therefore, by applying the lightguide module of the present disclosure, the number and position of light-guiding components can be adjusted according to the specifications of the spacing, quantity, and position of the indicator lights, without the need to redesign the mold. This not only saves mold opening costs but also shortens the overall development time, thereby enhancing market competitiveness. Additionally, it also offers environmental sustainability advantages.

Although the present disclosure has been disclosed above with specific preferred embodiments, it is not intended to limit the present disclosure. A person skilled in the art can still make some modifications and refinements without departing from the spirit and scope of the present disclosure. Therefore, the protection scope of the present disclosure should be defined by the claims below.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A lightguide module suitable for directing light provided by a first light source to a first light outlet and light provided by a second light source to a second light outlet, comprising:
a base;
a first light-guiding component movably disposed on the base, wherein the first light-guiding component includes a first light entering end and a first light exiting end, the first light entering end corresponding to the first light source, and the first light exiting end corresponding to the first light outlet;
a second light-guiding component movably disposed on the base, wherein the second light-guiding component includes a second light entering end and a second light exiting end, the second light entering end corresponding to the second light source, and the second light exiting end corresponding to the second light outlet.

2. The lightguide module according to claim 1, wherein the first light-guiding component includes a first light guide pipe, a first light entering portion, and a first light exiting portion, the first light entering portion is adjustably disposed at one end of the first light guide pipe, the first light exiting portion is adjustably disposed at the other end of the first light guide pipe, the first light entering end is located on the first light entering portion, the first light exiting end is located on the first light exiting portion, and the second light-guiding component includes a second light guide pipe, a second light entering portion, and a second light exiting portion, the second light entering portion is adjustably disposed at one end of the second light guide pipe, the second light exiting portion is adjustably disposed at the other end of the second light guide pipe, the second light entering end is located on the second light entering portion, the second light exiting end is located on the second light exiting portion.

3. The lightguide module according to claim 2, wherein the base includes a first slot, a second slot, and an opening, the first light guide pipe includes a first adjustment post and a first positioning post, the second light guide pipe includes a second adjustment post and a second positioning post, the first positioning post is adapted to move along the first slot, the second positioning post is adapted to move along the second slot, and the first adjustment post and the second adjustment post are adapted to move along the opening.

4. The lightguide module according to claim 3, wherein the first slot and the second slot are arranged along a first direction, the opening extends along a second direction, the first slot and the second slot each extend along the second direction, and the first direction is perpendicular to the second direction.

5. The lightguide module according to claim 4, wherein the first light entering end and the second light entering end are arranged along the first direction, and the first light exiting end and the second light exiting end are arranged along the second direction.

6. The lightguide module according to claim 4, wherein the first positioning post is tightly fitted within the first slot, the second positioning post is tightly fitted within the second slot, and the first adjustment post and the second adjustment post are tightly fitted within the opening.

7. The lightguide module according to claim 6, wherein at least one interference protrusion is formed on the first positioning post or the first adjustment post, the interference protrusion abutting against the first slot or the opening.

8. The lightguide module according to claim 2, further comprising a light-blocking strip disposed on the base and located between the first light guide pipe and the second light guide pipe.

9. A lightguide module suitable for directing light provided by a light source to a light outlet, comprising:
a base, including a plurality of slots and an opening;
at least one light-guiding component disposed on the base, wherein the light-guiding component includes a positioning post, an adjustment post, a light entering end, and a light exiting end, the light entering end corresponding to the light source, the light exiting end corresponding to the light outlet, the positioning post is inserted into one of the slots, and the adjustment post is inserted into the opening.

10. The lightguide module according to claim 9, wherein the light-guiding component includes a light guide pipe, a light entering portion, and a light exiting portion, the light entering portion is adjustably disposed at one end of the light guide pipe, the light exiting portion is adjustably disposed at the other end of the light guide pipe, the light entering end is located on the light entering portion, the light exiting end is located on the light exiting portion, and the positioning post and the adjustment post are formed on the light guide pipe.

11. The lightguide module according to claim 10, wherein the slots are arranged along a first direction, the opening extends along a second direction, the slots each extend along the second direction, and the first direction is perpendicular to the second direction.

12. The lightguide module according to claim 10, wherein the light entering portion is threadably disposed at one end of the light guide pipe, and the light exiting portion is threadably disposed at the other end of the light guide pipe.

13. The lightguide module according to claim 10, wherein the light entering portion is tightly fitted at one end of the light guide pipe, and the light exiting portion is tightly fitted at the other end of the light guide pipe.

14. The lightguide module according to claim 10, wherein the light entering portion is snap-fitted at one end of the light guide pipe, and the light exiting portion is snap-fitted at the other end of the light guide pipe.

15. The lightguide module according to claim 14, wherein each light guide pipe includes a plurality of first snap-fit holes and a plurality of second snap-fit holes, the light entering portion includes a first snap-fit protrusion, and the light exiting portion includes a second snap-fit protrusion, with the first snap-fit protrusion is selectively coupled to one of the first snap-fit holes, and the second snap-fit protrusion is selectively coupled to one of the second snap-fit holes.

16. The lightguide module according to claim 10, wherein the light guide pipe is adhesively fixed to the base.

17. A light-guiding component, comprising:
a light guide pipe, including a positioning post and an adjustment post, wherein the positioning post and the adjustment post are formed on the light guide pipe;
a light entering portion adjustably disposed at one end of the light guide pipe; and
a light exiting portion adjustably disposed at the other end of the light guide pipe.

18. The light-guiding component according to claim 17, wherein the light guide pipe is L-shaped.

19. The light-guiding component according to claim 17, wherein the light entering portion is threadably disposed at one end of the light guide pipe, and the light exiting portion is threadably disposed at the other end of the light guide pipe.

20. The light-guiding component according to claim 17, wherein the light entering portion is snap-fitted at one end of the light guide pipe, and the light exiting portion is snap-fitted at the other end of the light guide pipe, with each light guide pipe including a plurality of first snap-fit holes and a plurality of second snap-fit holes, the light entering portion including a first snap-fit protrusion, and the light exiting portion including a second snap-fit protrusion, the first snap-fit protrusion is selectively coupled to one of the first snap-fit holes, and the second snap-fit protrusion is selectively coupled to one of the second snap-fit holes.
